(19) United States
(12) Patent Application Publication
(10) Pub. No.: US 2011/0201342 A1
(43) Pub. Date: Aug. 18, 2011

(54) MINIMIZING LOCATION UPDATE IN CIRCUIT-SWITCHED FALLBACK

(75) Inventors: Curt WONG, Sammamish, WA (US); Lauri Kalevi LAHTINEN, Espoo (FI); Robert ZAUS, Munchen (DE)

(73) Assignee: NOKIA SIEMENS NETWORKS OY, Espoo (FI)

(21) Appl. No.: 12/706,589

(22) Filed: Feb. 16, 2010

(51) Int. Cl. H04W 72/04

(52) U.S. Cl. 455/450

(57) ABSTRACT

A method can include allocating a temporary mobile subscriber identity for a user equipment during a location update procedure. The method can also include allocating, during the allocating of the temporary mobile subscriber identity, a unique network resource identifier value for the whole network element, wherein temporary mobile subscriber identity allocation avoids being location area based. The method can further include providing, to the user equipment, a location area identifier, temporary mobile subscriber identity with the unique network resource identifier value, and an indication to skip location area identifier checking when performing circuit-switched fallback. Certain embodiments of the present invention can thus minimize the LAU by the UE and allow the network not to require perfect alignment of TA and LA.

### BACKGROUND

1. Field

In certain embodiments the occurrence of, and delay associated with, location updates can be minimized for the situation in which a user equipment (such as a mobile node or cellular telephone) is falling back from a Long Term Evolution (LTE) system to a second or third generation (2/3G). The minimization can be accomplished, for example, by the implementation of an indication that a user equipment is to avoid checking a location area identifier under certain circumstances.

2. Description of the Related Art

Circuit switched (CS) fallback (CSFB) in an evolved packet system (EPS) can, for example, help to provide voice and other CS-domain services by reuse of CS infrastructure when a user equipment (UE) is served by enhanced universal mobile telecommunication system (UMTS) terrestrial radio access network (E-UTRAN). Location area updates (LAUs) are used in UTRAN/global system for mobile communications (GSM) enhanced data rates for global evolution (EDGE) radio access network (RAN) (GERAN) to assist in mobility management of mobile devices, such as cellular telephones.

In a CSFB operating environment, an EPS track area (TA) and a mobile switching center (MSC) serving location area (LA) can be present. The TA and LA can be aligned such that, when the UE experiences fallback to 2/3G (second or third generation wireless), it can be covered by the expected MSC (i.e., the MSC in the corresponding LA). If the UE falls back to an LA other than the expected one(s), then the UE conventionally needs to perform a location area update (LAU) procedure before commencing the CS procedure (i.e., the setup procedure related to CS mobile originated (MO) or mobile terminated (MT)). This LAU contributes to the call setup delay; hence, it can degrade the level of performance in a voice call with an LTE UE using CSFB for voice.

In practice, aligning the TA/LA is not easy to achieve. There can, in particular, be a border where LA and TA are not aligned (e.g., different radio frequency (RF) propagation, etc.). One way to address TA/LA alignment inconsistencies is to employ list allocation for the CSFB UE and also to include an CSFB-specific hysteresis to minimize the ping-pong effect when the CSFB UE is moved between TAs. In such an approach, the UE could still fall back to the wrong LA while it is in the hysteresis threshold (i.e., the UE is at or near the border). Furthermore, the UE would not be camping to the best possible LTE cell because it is under this hysteresis threshold; hence, it can create more radio interference.

Additionally, an MSC pooling feature can minimize the occurrence of falling back to the wrong serving MSC. This, however, does not minimize the LAU procedure by the UE when the UE falls into a different LA than the expected one.

### SUMMARY

According to certain embodiments, the present invention is a method. The method includes allocating a temporary mobile subscriber identity for a user equipment during a location update procedure. The method also includes allocating, during the allocating of the temporary mobile subscriber identity, a unique network resource identifier value for the whole network element, wherein temporary mobile subscriber identity allocation avoids being location area based. The method further includes providing, to the user equipment, a location area identifier, temporary mobile subscriber identity with the unique network resource identifier value, and an indication to skip location area identifier checking when performing circuit-switched fallback.

In another embodiment, the present invention is a method. The method includes identifying, from a received message including a location area identifier, temporary mobile subscriber identity with a unique network resource identifier value, and an indication whether to skip location area identifier checking when performing circuit-switched fallback, whether the location area identifier checking is to be skipped when performing circuit-switched fallback. The method also includes, upon being redirected to a second or third generation wireless communication system, skipping location area identifier checking when the identifying indicates that the location area identifier checking is to be skipped.

In certain embodiments, the present invention is a computer-readable medium encoded with instructions that, when executed in hardware, perform a process. The process can include the features of the above-described methods.

A further embodiment of the present invention is an apparatus. The apparatus includes at least one memory including computer program code and at least one processor. The at least one memory and computer program code are configured to, with the at least one memory, cause the apparatus at least to allocate a temporary mobile subscriber identity for a user equipment during a location update procedure. The at least one memory and computer program code are also configured to, with the at least one memory, cause the apparatus at least to allocate, during the allocating of the temporary mobile subscriber identity, a unique network resource identifier value for the whole network element, wherein temporary mobile subscriber identity allocation avoids being location area based. The at least one memory and computer program code are further configured to, with the at least one memory, cause the apparatus at least to provide, to the user equipment, a location area identifier, temporary mobile subscriber identity with the unique network resource identifier value, and an indication to skip location area identifier checking when performing circuit-switched fallback.

An additional embodiment of the present invention is an apparatus that includes at least one memory including computer program code and at least one processor. The at least one memory and computer program code are configured to, with the at least one memory, cause the apparatus at least to identify, from a received message including a location area identifier, temporary mobile subscriber identity with a unique network resource identifier value, and an indication whether to skip location area identifier checking when performing circuit-switched fallback, whether the location area identifier checking is to be skipped when performing circuit-switched fallback. The at least one memory and computer program code are also configured to, with the at least one memory, cause the apparatus at least to, upon being redirected to a second or third generation wireless communication system, skip location area identifier checking when the identifying indicates that the location area identifier checking is to be skipped.

Another embodiment of the present invention is an apparatus. The apparatus includes means for allocating a temporary mobile subscriber identity for a user equipment during a location update procedure. The apparatus also includes means for allocating, during the allocating of the temporary mobile subscriber identity, a unique network resource identifier value for the whole network element, wherein temporary mobile subscriber identity allocation avoids being location area based. The apparatus further includes means for providing, to the user equipment, a location area identifier, temporary mobile subscriber identity with the unique network resource identifier value, and an indication to skip location area identifier checking when performing circuit-switched fallback.

An additional embodiment of the present invention is an apparatus that includes means for identifying, from a received message including a location area identifier, temporary mobile subscriber identity with a unique network resource identifier value, and an indication whether to skip location area identifier checking when performing circuit-switched fallback, whether the location area identifier checking is to be skipped when performing circuit-switched fallback. The apparatus also includes means for, upon being redirected to a second or third generation wireless communication system, skipping location area identifier checking when the identifying indicates that the location area identifier checking is to be skipped.

### BRIEF DESCRIPTION OF THE DRAWINGS

For proper understanding of the invention, reference should be made to the accompanying drawings, wherein:

FIG. 1 illustrates cases where track areas and location areas are not aligned.

FIG. 2 illustrates an MSC pooling feature to minimize the occurrence of falling back to the wrong serving MSC.

FIG. 3 illustrates functionality during a combined attach.

FIG. 4 illustrates functionality during a MO/MT call with CSFB.

FIG. 5 illustrates a method according to certain embodiments of the present invention.

FIG. 6 illustrates a method according to certain embodiments of the present invention.

FIG. 7 illustrates a system according to certain embodiments of the present invention.

FIG. 8 illustrates a signaling flow according to certain embodiments of the present invention.

### DETAILED DESCRIPTION OF THE PREFERRED EMBODIMENT(S)

Certain embodiments of the present invention minimize instances of location area update (LAU) by a user equipment (UE) and allow the network not to require perfect alignment of corresponding track area (TA) and location area (LA).

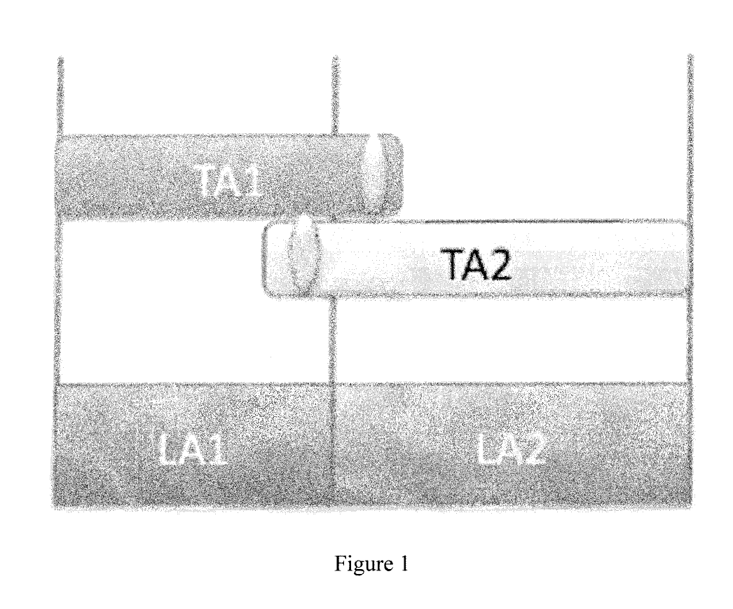

FIG. 1 illustrates the case where a first track area (TA1) and first location area (LA1) are not aligned and likewise for second track area (TA2) and second location area (LA2). The ovals in the figure represent the long term evolution (LTE) UE under two cases. In both cases, the UE will fall back to the wrong LA and the LAU procedure is conventionally expected to be performed by the UE.

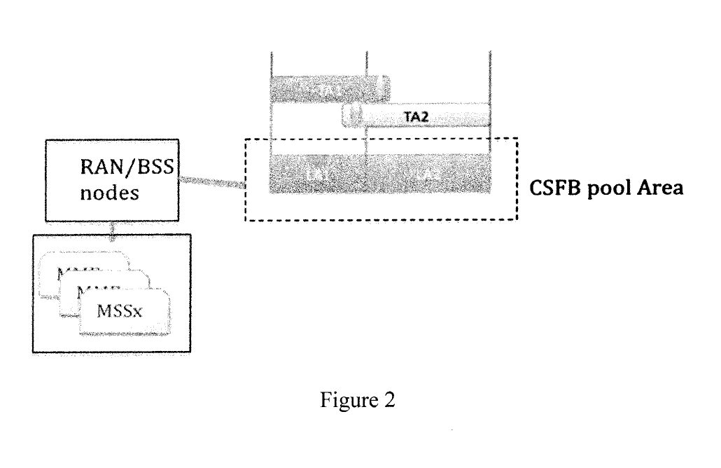

FIG. 2 illustrates a mobile services switching center (MSC) pooling feature that can help to minimize the occurrence of falling back to the wrong serving MSC. This approach may work fine as intended but it may not, by itself, avoid an unnecessary LAU procedure by the UE when the UE falls into a different LA than the expected one(s). FIG. 2 also shows a typical pool configuration, although other pool configurations are permitted.

Certain embodiments of the present invention build on top of, or are at least consistent with, the MSC pooling feature via modification of, for example, the mobile switching center server (MSS) and UE, as well as the network configuration.

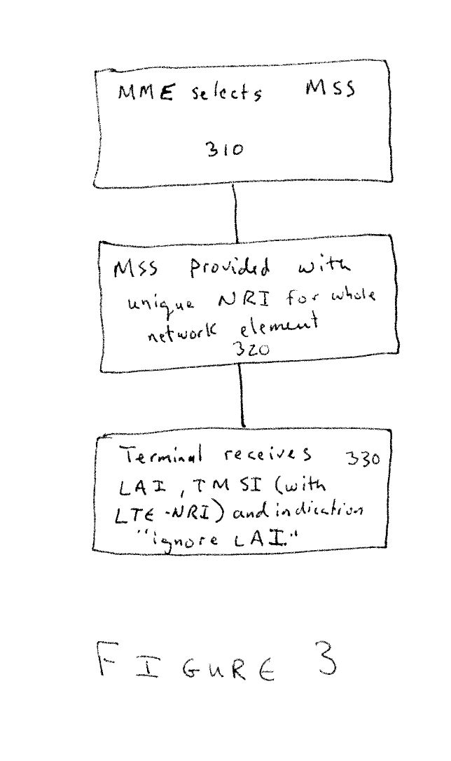

FIG. 3 illustrates functionality of certain embodiments of the present invention during a combined attach. During the combined long term evolution (LTE)/international mobile subscriber identity (IMSI) attach or track area update (TAU), the mobility management entity (MME) can select 310 a certain MSS. The MSS can be provided 320 with a unique network resource identifier (NRI) value for the whole network element. Thus, the temporary mobile subscriber identity (TMSI) allocation can avoid being location area (LA)-based. This NRI can be specifically referred to as an LTE-NRI. The terminal, in this figure, receives 330 a location area identity (LAI), TMSI (with LTE-NRI), and an indication of “ignore LAI” in the combined attach response. The term “ignore” here can have the sense of “skip.” There is no requirement that the LAI be checked with the result being ignored. Instead, the entire checking can be omitted.

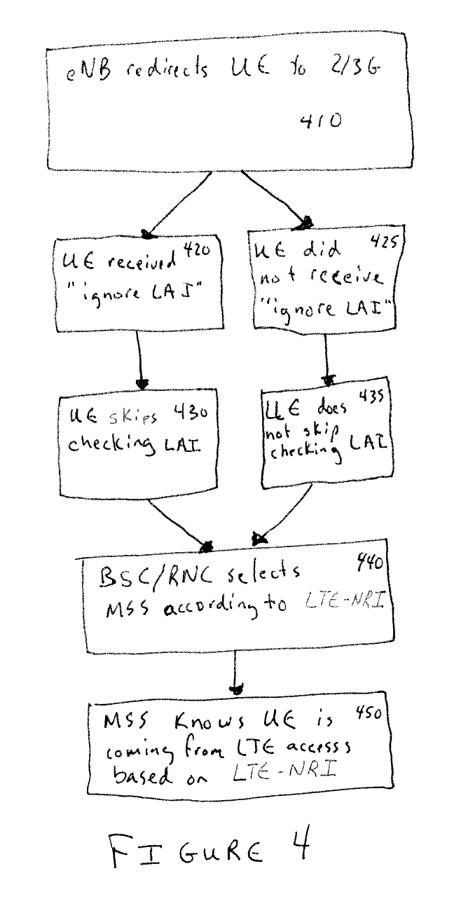

FIG. 4 illustrates functionality during a MO/MT (mobile originated or mobile terminated) call with CSFB. As shown in FIG. 4, the eNB redirects 410 the UE to 2/3G using any appropriate procedure for such redirection. Assuming the terminal has received 420 the “ignore LAI” indication during combined LTE/IMSI attach or TAU, terminal performs 430 cm-serv-req (MO) or paging-resp (MT) without checking the LAI. If the “ignore LAI” indication was not received 425, the terminal checks the LAI and performs a location update 435, if necessary, before sending the cm-serv-req or paging-resp. The base station controller (BSC)/radio network controller (RNC) can select 440 the appropriate MSS based on the LTE-NRI value. The BSC/RNC can make this selection according to any appropriate technique. The MSS knows 450 based on LTE-NRI value that the user is coming from LTE access and the LAI received in complete-layer-3-message may differ from the LA received during location update.

To implement certain embodiments of the present invention, it may be necessary to suitably configure the MSS and the BSC/RNC. For example, with respect to the MSS, the LTE-NRI may need to differ from the MSS normal NRI, if the LA is checked against the one received from radio access. Additionally, the TMSI allocation may need to be done for whole network element for LTE access (not LA based). Likewise, regarding the BSC/RNC, all BSCs/RNCs may need to be able to route the terminal initial messages based on the LTE-NRI value.

Thus, with the implementation of a MSC pooling feature, the CSFB support could be centralized to certain CSFB-capable MSSs, without the need to touch the existing legacy MSSs in the network. With certain embodiments of the present invention, the delay due to LAU is also minimized because the “ignore LAI” indication informs the UE that it can try to access the network without previous location update (LAU) procedure. Without that indication, if the UE is connected to an MSC with a very strict implementation, the MSC could reject the call attempt, thus introducing additional delay.

In other words, certain embodiments of the present invention enhance the pooling features mentioned above, such that when the UE falls back to 2/3G, the UE can just proceed directly with CS setup, e.g. cm-serv-req (MO) or paging-resp (MT), without checking the LAI. This is possible because the radio access network (RAN)/base station subsystem (BSS) will route the CS setup or page response to the correct MSS due to routing based on NRI with, for example, the following enhancements:

When the MSS is allocating a temporary mobile subscriber identity (TMSI) for the UE during location update procedure over SGs, it can allocate a unique NRI value for the whole network element, i.e., TMSI allocation is not LA based. As noted above, this can be called a LTE-NRI. The LTE-NRI can specifically be assigned by a visitor location register (VLR).

UE can be given the LAI, TMSI (with LTE-NRI) and an indication from the network that the UE can skip LAI checking when performing CSFB. This indication can be given to the UE during EPS/IMSI attached or combined TAU procedure.

3 When E-UTRAN redirects the UE to 2/3G using any suitable procedure, the UE that has received the “ignore LAI” indication can perform cm-serv-req (MO) or paging-resp (MT) without checking the LAI.

If the “ignore LAI” indication was not received, the UE can check the LAI and perform a location update if necessary, before sending a connection management service request (cm-serv-req) or paging response message (paging-resp) using any suitable procedure.

4. BSC/RNC can select the MSS based on the LTE-NRI value using any suitable procedure.

5. MSS can also be aware, based on LTE-NRI value, that the user is coming from LTE access and the LAI received in complete-layer-3-message may differ from the LA received during location update. Since the MSS has allocated a unique TMSI for this UE (in step 1), it can continue to perform normal CS call setup procedure without any risk of duplicate TMSI allocation issues.

It should be noted that the LTE-NRI can differ from the MSS normal NRI, if the LA is checked against the one received from radio access.

With the MSC pooling feature, the CSFB support can, therefore, be centralized to CSFB-capable MSSs, without need to modify the existing legacy MSSs in the network. With such embodiments of the present invention, the LA/TA alignment is not strictly related, and the delay due to LAU is also avoided because the “ignore LAI” indication informs the UE that it can try to access the network without a previous location update (LAU) procedure. Without this indication, as noted above, if the UE is connected to an MSC with a very strict implementation, the MSC could reject the call attempt, thus introducing additional delay.

When signaling gateway (SG) interface(s), SGs interface between MME and MSC, has been deployed only to two or a few MSCs in network (which are pooled), then other MSCs that provide services for 2G/3G in same network that do not have SGs can be configured in such a way that MSCs having SGs belong to the same pool with those other MSCs in the network.

Pooling can be done only between those MSCs that have SGs and each individual MSC that does not have SGs. If the pooling is used only in the LTE area and not in the 2/3G area, this would mean that the BSS/RAN would not have do the pooling for the location updates, but may have to do such pooling for the paging-responses and cm-service-requests. This sort of mixed mode operation may require modifications to the BSS/RAN.

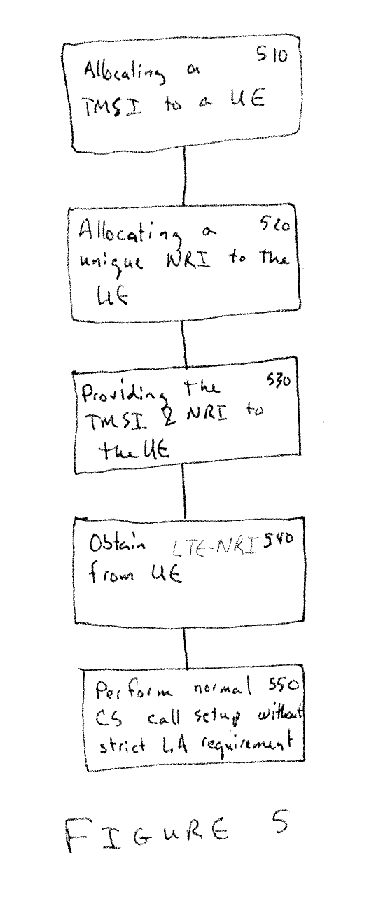

FIG. 5 illustrates a method according to certain embodiments of the present invention. The method of FIG. 5 can be performed by, for example, an MSS. As shown in FIG. 5, the method can include allocating 510 a temporary mobile subscriber identity for a user equipment during a location update procedure. The method can also include allocating 520, as part of allocating the temporary mobile subscriber identity and consequently such an operation, a unique network resource identifier value for the whole network element, wherein temporary mobile subscriber identity allocation is not location area based and consequently avoids being location area based. The illustrated method further includes providing 530, to the user equipment, a location area identifier, temporary mobile subscriber identity with the unique network resource identifier value, and an indication to skip location area identifier checking when performing circuit-switched fallback.

The illustrated method can further include obtaining 540 a circuit-switched fallback network resource identifier value from the user equipment. 4. The circuit-switched fallback network resource identifier value from the user equipment can be for an entire network element and not be location area-based. While this obtaining 540 can, in certain instances, be done by the same MSS that allocated the unique network resource identifier value, it is also possible that a different MSS (selected by a BSC/RNC) could perform this as well as the subsequent operations discussed below.

The method shown in FIG. 5 also includes performing 550 a normal circuit-switched call setup procedure on the user equipment, while being informed and therefore aware, based on the circuit-switched fallback network resource identifier value, that the user equipment is coming from long term evolution access and the location area identifier received in a complete-layer-3-message is permitted to differ from the location area received during location update.

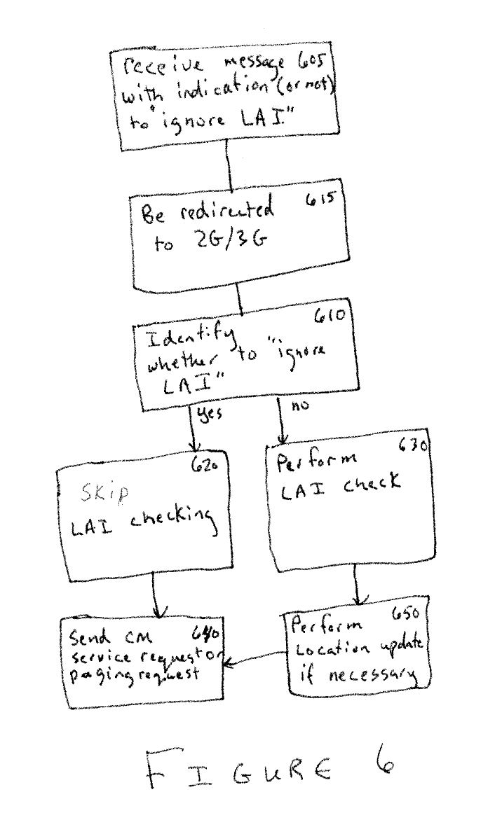

FIG. 6 illustrates a method according to certain embodiments of the present invention. The method of FIG. 6 can be performed by, for example, a user equipment. The method, as shown, includes identifying 610, from a received 605 message including a location area identifier, temporary mobile subscriber identity with a unique network resource identifier value, and an indication whether to skip location area identifier checking when performing circuit-switched fallback, whether the location area identifier checking is to be skipped when performing circuit-switched fallback. Upon being redirected 615 to a second or third generation wireless communication system, skipping 620 location area identifier checking when the identifying indicates that the location area identifier checking is to be skipped and performing 630 the location area identifier checking when the identifying fails to indicate that the location area identifier check is to be performed.

The method of FIG. 6 can also include, when the identifying indicates that the location area identifier checking is to be skipped, sending 640 a connection management service request or paging response message without checking the location area identifier. The method can also include, when the identifying fails to indicate that the location area identifier checking is to be skipped, checking 650 the location area identifier and performing a location update, if necessary, before sending a connection management service request or paging response message. The unique network resource identifier value can be a circuit-switched fallback network resource identifier value.

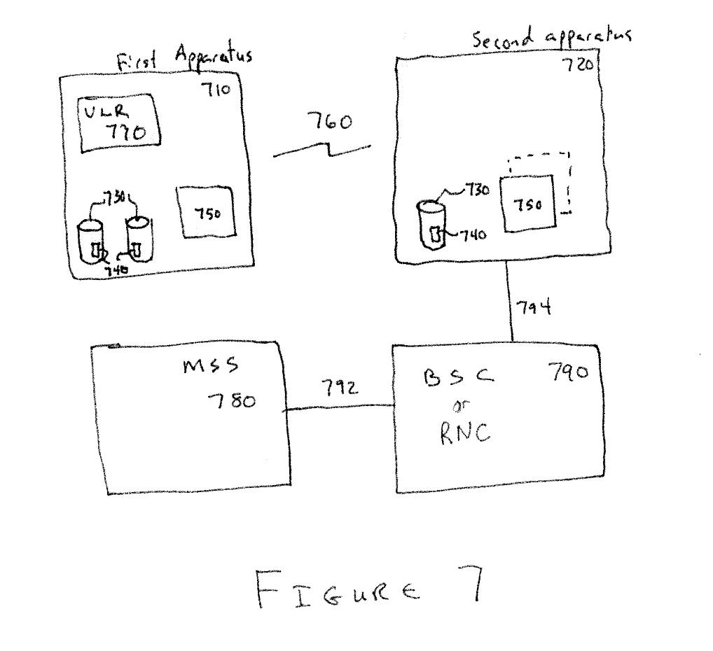

FIG. 7 illustrates a system according to certain embodiments of the present invention. The system includes a first apparatus 710 (which may be an MSS) and a second apparatus 720 (which may be a user equipment). The first apparatus 710 and the second apparatus 720 each include at least one memory 730 including computer program code 740. The first apparatus 710 and the second apparatus 720 may also include at least one processor 750. The at least one processor 750 and the at least one memory 730 including the computer program code 740 can be configured to cause their respective apparatuses to perform various methods, such as the methods illustrated in FIGS. 5-6.

The at least one processor 750 can be any suitable processor, such as a general purpose computer processor specially adapted to the particular implementation of an embodiment of the present invention, an application specific integrated circuit (ASIC), or one or more controllers. The at least one memory 730 can be any suitable storage device, such as random access memory (RAM) or read only memory (ROM), including such implementations as, for example, flash RAM. The at least one memory 730 can be on the same or a different chip from the at least one processor 750, and can be the on-board memory of a chip that includes the processor 750. The computer program code 740 can be any suitable set of computer-readable instructions, either (for example) in a compiled or interpreted format.

The first apparatus 710 and the second apparatus 720 can be connected via a connection that includes a wireless link 760 (although the connection need not be a direct connection). The system can include additional devices. For example, the first apparatus 710 can include a VLR 770. The system can also include an MSS 780, which may have a similar construction to the first apparatus 710. Another system element can be a BSC 790, which may be communicatively connected via connections 792 and 794 respectively to the MSS 780 and the second apparatus 720.

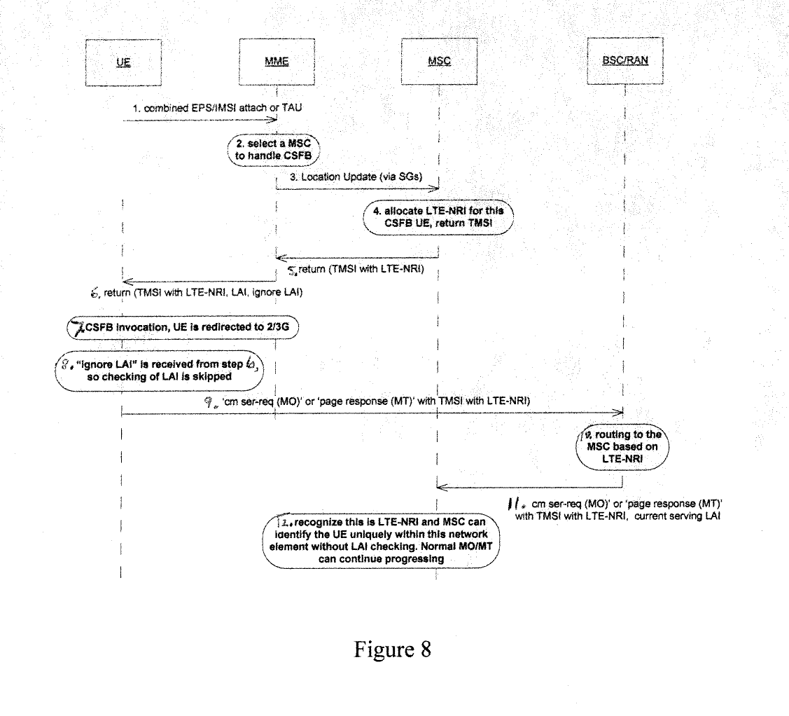

FIG. 8 illustrates a signaling flow according to certain embodiments of the present invention. As shown in FIG. 8, at (1) the UE can perform a combined EPS/IMSI attach or TAU. At (2), the MME can select an MSC to handle CSFB. Then, at (3), the MME can perform a location update (via SGs) with the MSC. The MSC can, at (4), allocate LTE-NRI for this CSFB UE and return TMSI. Next, the MSC can return, at (5), the TMSI with LTE-NRI to the MME. At (6), the MME can provide the TMSI with LTE-NRI, LAI, and “ignore LAI” to the UE. The UE can subsequently experience CSFB invocation, as UE is redirected to 2G/3G at (7).

Continuing at (8), because the UE has received an “ignore LAI” at step (6), checking of LAI is skipped. At (9), the UE sends ‘cm-ser-req (MO)’ or ‘page response (MT)’ with TMSI and LTE-NRI to a BSC/RAN. The BSC/RAN then, at (10) determines how to route to the appropriate MSC based on the LTE-NRI. Subsequently, at (11), the ‘cm-ser-req (MO)’ or ‘page response (MT)’ with TMSI and LTE-NRI is routed to an MSC for the currently serving LAI. The MSC can finally, at (12), recognize that this is an LTE-NRI and the MSC can identify the UE uniquely within this network element without LAI checking. Normal MO/MT can continue to progress.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
allocating a temporary mobile subscriber identity for a user equipment during a location update procedure;
allocating, during the allocating of the temporary mobile subscriber identity, a unique network resource identifier value for the whole network element, wherein temporary mobile subscriber identity allocation avoids being location area based;
providing, to the user equipment, a location area identifier, temporary mobile subscriber identity with the unique network resource identifier value, and an indication to skip location area identifier checking when performing circuit-switched fallback.

2. The method of claim 1, further comprising:
obtaining a circuit-switched fallback network resource identifier value from the user equipment.

3. The method of claim 2, further comprising:
performing a normal circuit-switched call setup procedure on the user equipment, while being informed, based on the circuit-switched fallback network resource identifier value, that the user equipment is coming from long term evolution access and the location area identifier received in a complete-layer-3-message is permitted to differ from the location area received during location update.

4. The method of claim 2, wherein the circuit-switched fallback network resource identifier value from the user equipment avoids being location area-based and serves to identify an entire network element.

5. The method of claim 1, wherein the method is performed by a mobile switching center server.

6. A method, comprising:
identifying, from a received message including a location area identifier, temporary mobile subscriber identity with a unique network resource identifier value, and an indication whether to skip location area identifier checking when performing circuit-switched fallback, whether the location area identifier checking is to be skipped when performing circuit-switched fallback;
upon being redirected to a second or third generation wireless communication system, skipping location area identifier checking when the identifying indicates that the location area identifier checking is to be skipped.

7. The method of claim 6, further comprising:
when the identifying indicates that the location area identifier checking is to be skipped, sending a connection management service request or paging response message without checking the location area identifier.

8. The method of claim 6, further comprising:
when the identifying fails to indicate that the location area identifier checking is to be skipped, checking the location area identifier and performing a location update before sending a connection management service request or paging response message.

9. The method of claim 6, wherein the unique network resource identifier value comprises a circuit-switched fallback network resource identifier value.

10. The method of claim 6, wherein the method is performed by a user equipment.

11. An apparatus, comprising:
at least one memory including computer program code; and
at least one processor,
wherein the at least one memory and computer program code are configured to, with the at least one memory, cause the apparatus at least to
allocate a temporary mobile subscriber identity for a user equipment during a location update procedure,
allocate, during the allocating of the temporary mobile subscriber identity, a unique network resource identifier value for the whole network element, wherein temporary mobile subscriber identity allocation avoids being location area based,
provide, to the user equipment, a location area identifier, temporary mobile subscriber identity with the unique network resource identifier value, and an indication to skip location area identifier checking when performing circuit-switched fallback.

12. The apparatus of claim 11, wherein the at least one memory and computer program code are also configured to, with the at least one memory, cause the apparatus at least to obtain a circuit-switched fallback network resource identifier value from the user equipment.

13. The apparatus of claim 12, wherein the at least one memory and computer program code are also configured to, with the at least one memory, cause the apparatus at least to perform a normal circuit-switched call setup procedure on the user equipment, while being informed, based on the circuit-switched fallback network resource identifier value, that the user equipment is coming from long term evolution access and the location area identifier received in a complete-layer-3-message is permitted to differ from the location area received during location update.

14. The apparatus of claim 12, wherein the circuit-switched fallback network resource identifier value from the user equipment avoids being location area-based and serves to identify an entire network element.

15. The apparatus of claim 11, wherein the apparatus comprises a mobile switching center server.

16. An apparatus, comprising:
at least one memory including computer program code; and
at least one processor,
wherein the at least one memory and computer program code are configured to, with the at least one memory, cause the apparatus at least to
identify, from a received message including a location area identifier, temporary mobile subscriber identity with a unique network resource identifier value, and an indication whether to skip location area identifier checking when performing circuit-switched fallback, whether the location area identifier checking is to be skipped when performing circuit-switched fallback;
upon being redirected to a second or third generation wireless communication system, skip location area identifier checking when the identifying indicates that the location area identifier checking is to be skipped.

17. The apparatus of claim 16, wherein the at least one memory and computer program code are also configured to, with the at least one memory, cause the apparatus at least to, when the identifying indicates that the location area identifier checking is to be skipped, send a connection management service request or paging response message without checking the location area identifier.

18. The apparatus of claim 16, wherein the at least one memory and computer program code are also configured to, with the at least one memory, cause the apparatus at least to, when the identifying fails to indicate that the location area identifier checking is to be skipped, check the location area identifier and perform a location update before sending a connection management service request or paging response message.

19. The apparatus of claim 16, wherein the unique network resource identifier value comprises a circuit-switched fallback network resource identifier value.

20. The apparatus of claim 16, wherein the apparatus comprises a user equipment.
